(19) United States
(12) Patent Application Publication
(10) Pub. No.: US 2024/0158709 A1
(43) Pub. Date: May 16, 2024

(54) PELLETIZED PRODUCTS AND ASSOCIATED SYSTEMS, DEVICES, AND METHODS

(71) Applicant: SUNCOKE TECHNOLOGY AND DEVELOPMENT LLC, Lisle, IL (US)

(72) Inventors: John Francis Quanci, Haddonfield, NJ (US); Jonathan Hale Perkins, Lisle, IL (US); John Michael Richardson, Devon, PA (US)

(21) Appl. No.: 18/511,621

(22) Filed: Nov. 16, 2023

Related U.S. Application Data
(60) Provisional application No. 63/384,024, filed on Nov. 16, 2022.

(51) Int. Cl. C10L 5/36; C10L 5/04; C10L 5/10; C10L 5/14; C10L 5/44

(52) U.S. Cl. CPC C10L 5/363; C10L 5/04; C10L 5/105; C10L 5/14; C10L 5/447; C10L 2290/02; C10L 2290/06; C10L 2290/24; C10L 2290/28; C10L 2290/60

(57) ABSTRACT

Pellet products, and associated systems, devices and methods are disclosed herein. A production system can include a heat processing assembly comprising an oven configured to process an input material at a processing temperature of at least 1,000° F. for a processing period to produce processed materials, and a pelletization assembly configured to pelletize at least some of the processed materials and one or more additives to generate the pellets. In some embodiments, individual pellets include two or more of coke, coke breeze, char, biochar, charcoal fines, biochar fines, or carbon-containing materials, and at least one of a binder or a cross-linker. A production method can include receiving an input material, processing the input material at a processing temperature of at least 1400° F. in an oven for a processing period to produce processed materials, and pelletizing at least some of the processed materials with one or more additives to produce the pellets.

### CROSS-REFERENCE TO RELATED APPLICATIONS

This application claims priority to U.S. Provisional Patent Application No. 63/384,024, filed Nov. 16, 2022, and titled “PELLETIZED PRODUCTS AND ASSOCIATED SYSTEMS, DEVICES, AND METHODS,” the disclosure of which is incorporated herein by reference in its entirety. This application is also related to U.S. patent application Ser. No. 18/511,148, filed Nov. 16, 2023, and titled “PRODUCTS COMPRISING CHAR AND CARBON, AND ASSOCIATED SYSTEMS, DEVICES, AND METHODS,” U.S. patent application Ser. No. 18/501,795, filed Nov. 3, 2023, and titled “COAL BLENDS, FOUNDRY COKE PRODUCTS, AND ASSOCIATED SYSTEMS, DEVICES, AND METHODS,” and U.S. patent application Ser. No. 18/052,760, filed Nov. 4, 2022, and titled “FOUNDRY COKE PRODUCTS, AND ASSOCIATED SYSTEMS, DEVICES, AND METHODS,” the disclosures of which are incorporated herein by reference in their entireties.

### TECHNICAL FIELD

The present technology is generally directed to production methods and systems for producing a product including a population of pellets.

### BACKGROUND

Manufacturing industrial products, such as coke and biomass, can often yield products that are too small in size to be used in their intended application or other applications. As a result, most of these small products are disposed of in landfills, leading to waste. One solution is to pelletize the small products to form pellets that are bigger in size, but certain properties of the input materials can make pelletization challenging. For example, the relatively high and variable moisture content of the input materials can lead to manufacturing difficulties and pellets with poorer quality. As another example, the varying particle sizes and composition of the input materials can pose challenges in achieving consistent pellet properties. The presence of impurities like ash or contaminants can also impact the mechanical strength and combustion characteristics of the pellets.

One method associated with the pelletization process is torrefaction, which involves heat processing carbonaceous materials under a controlled condition (e.g., at temperatures between 400° F. and 600° F., and in an oxygen-limited or deprived environment). Another method is the “Thompson Coking Process,” which treats coal to be devolatilized and produces a fused mass of coke having a predetermined porosity and strength. Such methods may remove or reduce volatile matter (VM) and produce a product with an increased content of the element carbon, but are often associated with long operating times and may yield pellets that do not meet certain quality standards for desired applications.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1A depicts an isometric, partial cut-away view of a portion of a horizontal heat recovery plant configured in accordance with embodiments of the present technology.

FIG. 1B depicts a sectional view of a horizontal heat recovery oven configured in accordance with embodiments of the present technology.

FIG. 2 depicts a schematic production system in accordance with embodiments of the present technology.

FIG. 3 depicts a flowchart illustrating a production process for producing a population of pellets in accordance with embodiments of the present technology.

FIG. 4 depicts a flowchart illustrating another production process for producing a population of pellets in accordance with embodiments of the present technology.

A person skilled in the relevant art will understand that the features shown in the drawings are for purposes of illustration, and variations, including different or additional features and arrangements thereof, are possible.

### DETAILED DESCRIPTION

### I. Overview

The present technology is generally directed to production systems and methods for producing pellets or pellet products. Coal is processed in coke facilities to produce coke products of varying size, including foundry of 4+″, egg of approximately 2×4″, stove of 1×2″, and breeze of less than 1″ or ¾″. While the foundry and egg can be sold as product, the breeze is generally too fine to be sold as a product. The industry has not been successful in finding a method of consuming or disposing of this material, and thus a major portion of the breeze generated in the United States is landfilled.

Embodiments of the present technology attempt to mitigate this issue associated with wasting breeze and other traditional waste materials by pelletizing these particulates to produce a pellet product with underlying value for multiple industries. As described herein, some embodiments of the present technology can include an oven (e.g., a coke oven, a devolatilization oven, a pyrolysis oven, a blast furnace) configured to receive and heat an input material (e.g., coal) at a processing temperature of at least 1,000° F. to produce processed materials, which can include coke products (e.g., foundry) and particulates (e.g., breeze). In some embodiments, the processed materials include pyrolysis products. The particulates can be pelletized to produce a population of pellets that include the component of interest. In some embodiments, the particulates may be mixed with other particulate material(s) from a different source (e.g., iron fines, anthracite fines, coal fines, metal fines, blast furnace dust, baghouse fines, waste materials, petroleum coke breeze, anthracite fines, and/or calcined anthracite fines), and the mixed particulate materials may be pelletized into products having a size of at least 1/25″, 1/23″, 1/20″, 1/16″, 1/10″, ⅛″, ⅕″, ¼″, ⅓″, ½″, ¾″, 1″, etc. In some embodiments, before pelletization, the particulate materials may be tuned such that the produced pellets have a desired property (e.g., density, chemical composition, size, strength, degradation profile, moisture content, etc.) specified by a downstream user or determined according to an intended use of the produced pellets.

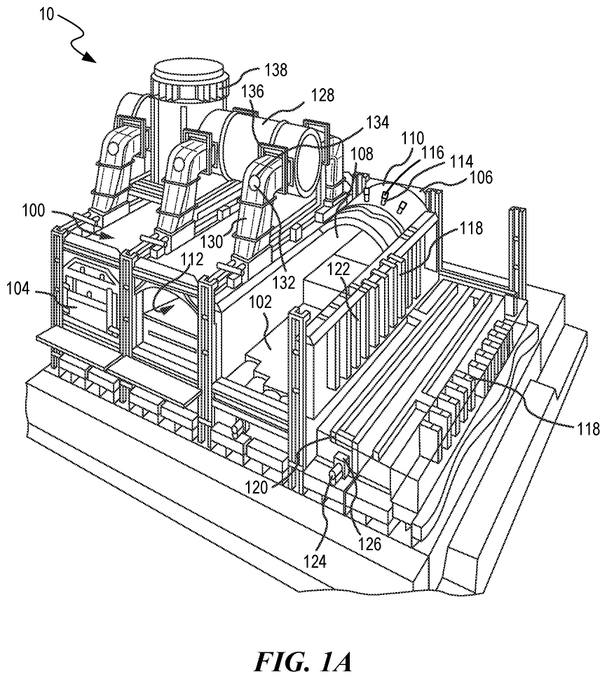

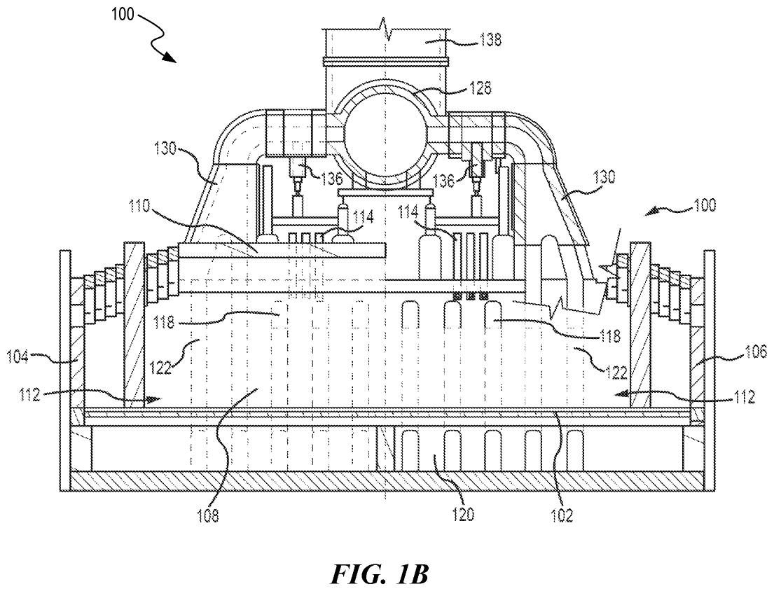

Specific details of several embodiments of the technology are described below with reference to FIGS. 1A-3. Other details describing well-known structures and systems often associated with combustion facilities, pelletization facilities, automated control systems have not been set forth in the following disclosure to avoid unnecessarily obscuring the description of the various embodiments of the technology. Many of the details, dimensions, angles, and other features shown in the Figures are merely illustrative of particular embodiments of the technology. Accordingly, other embodiments can have other details, dimensions, angles, and features without departing from the spirit or scope of the present technology. A person of ordinary skill in the art, therefore, will accordingly understand that the technology may have other embodiments with additional elements, or the technology may have other embodiments without several of the features shown and described below with reference to FIGS. 1A-3.

### II. Production System

FIG. 1A depicts a partial cut-away view of a portion of an HHR plant 10 configured in accordance with embodiments of the present technology. FIG. 1B depicts a sectional view of an HHR oven (or referred to as oven for brevity) 100 configured in accordance with embodiments of the present technology. It is understood that the HHR oven is provided here merely for illustration purposes and not intended to limit the scope of the present disclosure. In some embodiments, the oven 100 may be a non-heat recovery oven (e.g., a byproduct oven). In some embodiments, the oven 100 may be a different type of combustion oven than an HHR oven. In some embodiments, the oven 100 may be a heat processing oven including, e.g., a devolatilization oven, a pyrolysis oven, or a blast furnace.

The oven 100 includes an open cavity defined by an oven floor 102, a pusher side oven door 104, an output side oven door 106 opposite the pusher side oven door 104, opposite sidewalls 108 that extend upwardly from the floor 102 and between the pusher side oven door 104 and output side oven door 106, and a crown 110, which forms a top surface of the open cavity of an oven chamber 112. Controlling air flow and pressure inside the oven chamber 112 plays a significant role in the efficient operation of the heat processing cycle. Embodiments of the present technology include one or more crown air inlets 114 that allow primary combustion air into the oven chamber 112. In some embodiments, multiple crown air inlets 114 penetrate the crown 110 in a manner that selectively places oven chamber 112 in open fluid communication with the ambient environment outside the oven 100. The oven 100 may include an uptake elbow air inlet (not shown in FIG. 1A or 1B) having an air damper 116, which can be positioned at any of a number of positions between fully open and fully closed to vary an amount of air flow through the air inlet. Other oven air inlets, including door air inlets and the crown air inlets 114 include air dampers 116 that operate in a similar manner. The uptake elbow air inlet may be positioned to allow air into the common tunnel 128, whereas the door air inlets and the crown air inlets 114 vary an amount of air flow into the oven chamber 112. While embodiments of the present technology may use crown air inlets 114, exclusively, to provide primary combustion air into the oven chamber 112, other types of air inlets, such as the door air inlets, may be used in particular embodiments without departing from aspects of the present technology.

Various air inlets can be used with or without one or more air distributors to direct, circulate, and/or distribute air within the oven chamber. The term “air”, as used herein, can include ambient air, oxygen, oxidizers, nitrogen, nitrous oxide, diluents, combustion gases, air mixtures, oxidizer mixtures, flue gas, recycled vent gas, steam, gases having additives, inerts, heat-absorbers, liquid phase materials such as water droplets, multiphase materials such as liquid droplets atomized via a gaseous carrier, aspirated liquid fuels, atomized liquid heptane in a gaseous carrier stream, fuels such as natural gas or hydrogen, cooled gases, other gases, liquids, or solids, or a combination of these materials. In various embodiments, the air inlets and/or distributors can function (i.e., open, close, modify an air distribution pattern, etc.) in response to manual control or automatic advanced control systems. The air inlets and/or air distributors can operate on a dedicated advanced control system or can be controlled by a broader draft control system that adjusts the air inlets and/or distributors as well as uptake dampers, sole flue dampers, and/or other air distribution pathways within coke oven systems.

In operation, volatile gases emitted from input materials positioned inside the oven chamber 112 can collect in the crown and be drawn downstream into downcomer channels 118 formed in one or both sidewalls 108. The downcomer channels 118 can fluidly connect the oven chamber 112 with a sole flue 120, which is positioned beneath the oven floor 102. The sole flue 120 can form a circuitous path beneath the oven floor 102. Volatile gases emitted from the input materials can be combusted in the sole flue 120, thereby, generating heat to support the processing of the input materials to produce processed materials (e.g., reduction of coal into coke). The downcomer channels 118 are fluidly connected to uptake channels 122 formed in one or both sidewalls 108. A secondary air inlet 124 can be provided between the sole flue 120 and atmosphere, and the secondary air inlet 124 can include a secondary air damper 126 that can be positioned at any of a number of positions between fully open and fully closed to vary the amount of secondary air flow into the sole flue 120. The uptake channels 122 are fluidly connected to a common tunnel 128 by one or more uptake ducts 130. A tertiary air inlet 132 can be provided between the uptake duct 130 and atmosphere. The tertiary air inlet 132 can include a tertiary air damper 134, which can be positioned at any of a number of positions between fully open and fully closed to vary the amount of tertiary air flow into the uptake duct 130.

Each uptake duct 130 includes an uptake damper 136 that may be used to control gas flow through the uptake ducts 130 and within the ovens 100. The uptake damper 136 can be positioned at any number of positions between fully open and fully closed to vary the amount of oven draft in the oven 100. The uptake damper 136 can comprise any automatic or manually-controlled flow control or orifice blocking device (e.g., any plate, seal, block, etc.). For example, the uptake damper 136 is set at a flow position between 0 and 2, which represents “closed,” and 14, which represents “fully open.” It is contemplated that even in the “closed” position, the uptake damper 136 may still allow the passage of a small amount of air to pass through the uptake duct 130. Similarly, it is contemplated that a small portion of the uptake damper 136 may be positioned at least partially within a flow of air through the uptake duct 130 when the uptake damper 136 is in the “fully open” position. It will be appreciated that the uptake damper may take a nearly infinite number of positions between 0 and 14. Some exemplary settings for the uptake damper 136, increasing in the amount of flow restriction, include: 12, 10, 8, and 6. In some embodiments, the flow position number simply reflects the use of a fourteen inch uptake duct, and each number represents the amount of the uptake duct 130 that is open, in inches. Otherwise, it will be understood that the flow position number scale of 0-14 can be understood simply as incremental settings between open and closed.

As used herein, “draft” indicates a negative pressure relative to atmosphere. For example, a draft of 0.1 inches of water indicates a pressure of 0.1 inches of water below atmospheric pressure. Inches of water is a non-SI unit for pressure and is conventionally used to describe the draft at various locations in a coke plant. In some embodiments, the draft ranges from about 0.12 to about 0.16 inches of water. If a draft is increased or otherwise made larger, the pressure moves further below atmospheric pressure. If a draft is decreased, drops, or is otherwise made smaller or lower, the pressure moves towards atmospheric pressure. By controlling the oven draft with the uptake damper 136, the air flow into the oven 100 from the crown air inlets 114, as well as air leaks into the oven 100, can be controlled. Typically, as shown in FIG. 1B, an individual oven 100 includes two uptake ducts 130 and two uptake dampers 136, but the use of two uptake ducts and two uptake dampers is not a necessity; a system can be designed to use just one or more than two uptake ducts and two uptake dampers.

In operation, processed materials (e.g., coke, char, biochar) are produced in the ovens 100 by first charging an input material (e.g., coal, wood, biomass) into the oven chamber 112, heating the input material in an oxygen limited (e.g., oxygen depleted) environment, driving off the volatile fraction of the input material input material and then oxidizing the VM within the oven 100 to capture and use the heat given off.

In some embodiments, the input material, or referred to as a feedstock, may include at least one of carbon, nitrogen, oxygen, an alkali metal, aluminum, iron, a transition metal, or the like, or a combination thereof. In some embodiments, the input material may include at least one of a carbonaceous feedstock, a non-metal feedstock, or a metal-containing feedstock. In some embodiments, the carbonaceous feedstock may include at least one of coal, wood, a petroleum residue, a biomass feedstock, or a waste feedstock. In some embodiments, the non-metal feedstock may include a N-containing feedstock, limestone (CaCO₃), or quartz (SiO₂) In some embodiments, the metal-containing feedstock may include a raw mineral material or a recycled metal-containing material. In some embodiments, the transition metal may include at least one of copper, iron, cobalt, vanadium, zinc, nickel, chromium, manganese, scandium, titanium, gold, hafnium, molybdenum, tungsten, silver, platinum, ruthenium, rhodium, niobium, zirconium, technetium, iridium, osmium, palladium, tantalum, yttrium, rutherfordium, cadmium, rhenium, roentgenium, seaborgium, dubnium, hassium, meitnerium, bohrium, darmstadtium, or copernicium.

For example, the input material may include a carbon-containing feedstock, e.g., coal. The coal volatiles are oxidized within the oven 100 over an extended coking cycle and release heat to regeneratively drive the carbonization of the coal to coke. The coking cycle begins when the pusher side oven door 104 is opened and coal is charged onto the oven floor 102 in a manner that defines a coal bed. Heat from the oven (due to the previous coking cycle) starts the carbonization cycle. In many embodiments, no additional fuel other than that produced by the coking process is used. Roughly half of the total heat transfer to the coal bed is radiated down onto the top surface of the coal bed from the luminous flame of the coal bed and the radiant oven crown 110. The remaining half of the heat is transferred to the coal bed by conduction from the oven floor 102 which is convectively heated from the volatilization of gases in the sole flue 120. In this way, a carbonization process “wave” of plastic flow of the coal particles and formation of high strength cohesive coke proceeds from both the top and bottom boundaries of the coal bed.

In some embodiments, each oven 100 is operated at negative pressure so air is drawn into the oven during the reduction process due to the pressure differential between the oven 100 and atmosphere. Primary air for combustion is added to the oven chamber 112 to at least partially oxidize the volatiles from the input material. In some embodiments, the amount of this primary air is controlled so that only a portion of the volatiles released from the coal are combusted in the oven chamber 112, thereby, releasing only a fraction of their enthalpy of combustion within the oven chamber 112. In various embodiments, the primary air is introduced into the oven chamber 112 above the coal bed through the crown air inlets 114, with the amount of primary air controlled by the crown air dampers 116. In other embodiments, different types of air inlets may be used without departing from aspects of the present technology. For example, primary air may be introduced to the oven through air inlets, damper ports, and/or apertures in the oven sidewalls or doors. Regardless of the type of air inlet used, the air inlets can be used to maintain the desired operating temperature inside the oven chamber 112. Increasing or decreasing primary air flow into the oven chamber 112 through the use of air inlet dampers may increase or decrease VM combustion in the oven chamber 112 and, hence, temperature.

An oven 100 may be provided with crown air inlets 114 configured, in accordance with embodiments of the present technology, to introduce combustion air through the crown 110 and into the oven chamber 112. In one embodiment, three crown air inlets 114 are positioned between the pusher side oven door 104 and a mid-point of the oven 100, along an oven length. Similarly, three crown air inlets 114 are positioned between the coke side oven door 106 and the mid-point of the oven 100. It is contemplated, however, that one or more crown air inlets 114 may be disposed through the oven crown 110 at various locations along the oven's length. The chosen number and positioning of the crown air inlets depends, at least in part, on the configuration and use of the oven 100. Each crown air inlet 114 can include an air damper 116, which can be positioned at any of a number of positions between fully open and fully closed, to vary the amount of air flow into the oven chamber 112. In some embodiments, the air damper 116 may, in the “fully closed” position, still allow the passage of a small amount of ambient air to pass through the crown air inlet 114 into the oven chamber. Accordingly, various embodiments of the crown air inlets 114, uptake elbow air inlet, or door air inlet, may include a cap that may be removably secured to an open upper end portion of the particular air inlet. The cap may substantially prevent weather (such as rain and snow), additional ambient air, and other foreign matter from passing through the air inlet. It is contemplated that the oven 100 may further include one or more distributors configured to channel/distribute air flow into the oven chamber 112.

In various embodiments, the crown air inlets 114 are operated to introduce ambient air into the oven chamber 112 over the course of the heat processing cycle much in the way that other air inlets, such as those typically located within the oven doors, are operated. However, use of the crown air inlets 114 provides a more uniform distribution of air throughout the oven crown, which has shown to provide better combustion, higher temperatures in the sole flue 120 and later cross over times when the reactions in the oven 100 change from an exothermic process to an endothermic process. The uniform distribution of the air in the crown 110 of the oven 110 reduces the likelihood that the air will contact the surface of the feedstock bed and create hot spots that create burn losses on the feedstock surface. Rather, the crown air inlets 114 substantially reduce the occurrence of such hot spots, creating a uniform feedstock bed surface as the heat processing proceeds. In particular embodiments of use, the air dampers 116 of each of the crown air inlets 114 are set at similar positions with respect to one another. Accordingly, where one air damper 116 is fully open, all of the air dampers 116 can be placed in the fully open position; if one air damper 116 is set at a half open position, all of the air dampers 116 can be set at half open positions. However, in particular embodiments, the air dampers 116 can be changed independently from one another. In various embodiments, the air dampers 116 of the crown air inlets 114 can be opened up quickly after the oven 100 is charged or right before the oven 100 is charged. A first adjustment of the air dampers 116 to a ¾ open position is made at a time when a first door hole burning would typically occur. A second adjustment of the air dampers 116 to a ½ open position is made at a time when a second door hole burning would occur. Additional adjustments are made based on operating conditions detected throughout the coke oven 100.

The partially combusted gases pass from the oven chamber 112 through the downcomer channels 118 into the sole flue 120 where secondary air is added to the partially combusted gases. The secondary air is introduced through the secondary air inlet 124. The amount of secondary air that is introduced is controlled by the secondary air damper 126. As the secondary air is introduced, the partially combusted gases are more fully combusted in the sole flue 120, thereby, extracting the remaining enthalpy of combustion which is conveyed through the oven floor 102 to add heat to the oven chamber 112. The fully or nearly-fully combusted exhaust gases exit the sole flue 120 through the uptake channels 122 and then flow into the uptake duct 130. Tertiary air is added to the exhaust gases via the tertiary air inlet 132, where the amount of tertiary air introduced is controlled by the tertiary air damper 134 so that any remaining fraction of non-combusted gases in the exhaust gases are oxidized downstream of the tertiary air inlet 132. At the end of the heat processing cycle, the input material has processed to produce processed materials. The processed materials may be removed from the oven 100 through the output side oven door 106 utilizing a mechanical extraction system, such as a pusher ram. Finally, the processed materials may be quenched (e.g., wet or dry quenched). In some embodiments, the oven 100 may be configured to allow the processed materials to cool before the processed materials are removed from the oven 100. At least a portion of the heat from the cooling of the processed materials inside the oven 100 or outside the oven 100 may be recycled and utilized. For instance, the heat from the cooling of the processed materials inside the oven 100 may be used to maintain the temperature inside the oven 100, or dry fresh input material. As another example, the heat from the cooling of the processed materials inside the oven 100 may be used to preheat fresh input material before it is fed to the oven 100, or heat water to generate steam suitable for use in the plant 10 or somewhere else.

In some embodiments, the processed materials may include particulates and materials of a larger dimension than the particulates. Merely by way of example with reference to the input material including coal, the processed materials may include coke and coke breeze. In some embodiments, the processed materials may include coke, char, biochar, coke breeze, char fines, or the like, or a combination thereof. In some embodiments, the processed materials may be processed (e.g., sized) to separate the particulates from the materials of a larger dimension. In some embodiments, the particulates may be further processed by way of, e.g., pelletization, as described elsewhere in the present disclosure.

In some embodiments, the heat processing in the oven 100 may proceed and be controlled by a control system. The input material may be processed in the oven 100 for a processing period. During at least a portion of the processing period, the heat processing may proceed at a processing temperature of at least 1,000° F. In some embodiments, during at least a portion of the processing period, the processing temperature may be at least or above 1,100° F., 1,200° F., 1,300° F., 1,400° F., 1,500° F., 1,600° F., 1,800° F., 2,000° F., 2,500° F. In some embodiments, during at least a portion of the processing period, the processing temperature may reach up to 2800° F. In some embodiments, the processing period may be no more than 5 days, 3 days, 2 days, 1 day, 18 hours, 12 hours, 8 hours, 6 hours, or 4 hours.

In some embodiments, the processing period may be set before the heat processing starts. In some embodiments, the processing period may be adjusted substantially real time as the heat processing proceeds. In some embodiments, the processing period may be determined or controlled based on an operation parameter relating to the heat processing in the oven 100. Exemplary operation parameters include at least one of a temperature at an opening of or at a location inside the oven 100, a composition of an exhaust (or referred to as exhaust gas) of the oven 100, a gas flow rate of the exhaust, or a temperature at an external surface of the oven 100.

In some embodiments, the output rate of the oven 100 may in the range from 0.1 tons per hour to 1 ton per hour. In some embodiments, the production system 200 may include multiple ovens 100. The output rate of the production system 200 that includes multiple ovens 100 may be multiple times of the output rate of one oven 100. In some embodiments, at least two of the multiple ovens 100 are thermally coupled such that one constitutes a source of heat to the other. For example, a second oven 100 is configured to heat materials that undergo an exothermic process, and at least a portion of the heat generated in the exothermic process in the second oven 100 is transferred to a first oven 100 that is thermally coupled to the second oven 100. The duration of the exothermic process in the second oven may at least partially overlap with the heat processing of the input material in the first oven 100. In some embodiments, only a portion of the process in the second oven may be exothermic, and the exothermic portion of the process in the second oven may at least partially overlap with the heat processing of the input material in the first oven 100. As another example, the production system may include three ovens 100 arranged side by side so that two side ovens 100 are located on the opposite sides of the middle oven 100; at least one of the two side ovens 100 may be thermally coupled with the middle oven 100 such that the at least one side oven 100 may constitute a source of heat to the middle oven 100.

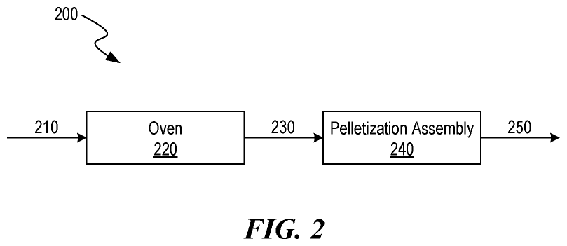

FIG. 2 depicts a schematic of a production system 200 in accordance with embodiments of the present technology. In some embodiments, the production system 200 may include an oven 220 and a pelletization assembly 240. The oven 220 can be identical to the oven(s) 100 described above with reference to FIGS. 1A and 1B, or have any one or more of the features described therein. In some embodiments, the oven 220 may include a coke oven, a devolatilization oven, a pyrolysis oven, a blast furnace, or the like, or a combination thereof. An input material (or referred to as feedstock) 210 may be provided to the oven 220 and processed at a processing temperature of at least 1,000° F. for a processing period to produce processed materials. In some embodiments, the processing of the input material 210 in the oven 220 may include a pyrolysis process. In some embodiments, the processed materials include pyrolysis products. The processed materials may include particulates 230, which may be pelletized in the pelletization assembly 240 to produce a population of pellets 250.

In some embodiments, the production system 200 may include a plant that includes one or more ovens 220, as described with reference to FIGS. 1A and 1B. As such, the oven 220 can be a heat recovery oven, or a non-heat recovery oven (e.g., a byproduct oven).

In some embodiments, the input material, or referred to as a feedstock, may include at least one of carbon, nitrogen, oxygen, an alkali metal, aluminum, iron, a transition metal, or the like, or a combination thereof. In some embodiments, the input material may include at least one of a carbonaceous feedstock, a non-metal feedstock, or a metal-containing feedstock. In some embodiments, the carbonaceous feedstock may include at least one of coal, wood, a petroleum residue, a biomass feedstock, or a waste feedstock. In some embodiments, a non-metal feedstock may include a feedstock high in nitrogen, limestone (CaCO₃), or quartz (SiO₂). In some embodiments, the metal-containing feedstock may include a raw mineral material or a recycled metal-containing material. In some embodiments, the transition metal may include at least one of copper, iron, cobalt, vanadium, zinc, nickel, chromium, manganese, scandium, titanium, gold, hafnium, molybdenum, tungsten, silver, platinum, ruthenium, rhodium, niobium, zirconium, technetium, iridium, osmium, palladium, tantalum, yttrium, rutherfordium, cadmium, rhenium, roentgenium, seaborgium, dubnium, hassium, meitnerium, bohrium, darmstadtium, or copernicium. The input material may include at least one component of interest that may also be included in the particulates and/or produced pellets.

In some embodiments, at least some of the input material have a smallest cross-sectional dimension of at least 2 inches, 3 inches, 4 inches, 5 inches, or 6 inches. In some embodiments, the production system 200 may include a device, e.g., a grinder or mill, configured to reduce the size of the input material before the input material is combusted in the oven 220.

During at least a portion of the processing period, the heat processing may proceed at a processing temperature of at least 1,000° F. In some embodiments, during at least a portion of the processing period of the heat processing, the processing temperature may be at least or above 1,100° F., 1,200° F., 1,300° F., 1,400° F., or 1,500° F., 1,600° F., 1,800° F., 2,000° F., 2,500° F. In some embodiments, during at least a portion of the processing period of the heat processing, the processing temperature may go up to 2800° F.

In some embodiments, the processing period may be no more than 5 days, 3 days, 2 days, 1 day, 18 hours, 12 hours, 8 hours, 6 hours, or 4 hours. In some embodiments, the processing period may be set before the heat processing starts. In some embodiments, the processing period may be adjusted substantially real time as the heat processing proceeds. In some embodiments, the processing period may be determined or controlled based on an operation parameter relating to the heat processing in the oven 100. Exemplary operation parameters include at least one of a temperature at an opening of or at a location inside the oven 100, a composition of an exhaust (or referred to as exhaust gas) of the oven 100, a gas flow rate of the exhaust, or a temperature at an external surface of the oven 100.

In some embodiments, the combustion temperature and/or the duration of the combustion period may be determined or adjusted in a coordinated manner based on one or more considerations including, e.g., the input material (e.g., composition, dimension, or the like, or a combination thereof), an operation parameter relating to the heat processing as described above, a desired property of the processed materials, the particulates, and/or the produced pellets.

In some embodiments, the processed materials may be cooled in the oven 220, and the heat recouped from the cooling may be reused. See relevant description of FIGS. 1A and 1B, which are not repeated here.

In some embodiments, the processed materials may include particulates 230 and materials of a larger dimension than the particulates. In some embodiments, the processed materials may include at least one, two, or more of coke, char, biochar, coke breeze, petroleum coke breeze, calcined anthracite fines, char fines, or the like, or a combination thereof. Merely by way of example with reference to an input material including coal, the processed materials may include coke and coke breeze. As another example with reference to an input material including wood, the processed materials may include char and char fines. In some embodiments, the processed materials can comprise at least one or two of coke, coke breeze, char, or biochar. As a further example with reference to an input material including biomass, the processed materials may include biochar and biochar fines. In some embodiments, the processed materials may be processed to separate the particulates 230 from the materials of a larger dimension. For example, the separation may be performed manually or automatically using, e.g., a sieve.

In some embodiments, the processed materials can include coke and/or coked products with a relatively low Coke Strength After Reaction (CSR) and a relatively high Coke Reactivity Index (CRI). For example, the coke and/or coked products can have (i) a CSR of no more than 20%, 15%, 10%, 5%, 2%, 1%, 0.5%, 0.1%, or within a range of 0.1-2%, and/or (ii) a CRI of at least 30%, 40%, 50%, 60%, or within a range of 30-60%.

In some embodiments, the particulates 230 may include at least one of charcoal fines, coal fines, petroleum coke breeze, or coke breeze. In some embodiments, the particulates 230 from the heat processing may be mixed with an additional particulate material from a source other than the heat processing of the input material. Such additional particulate materials may include, e.g., a raw particulate material (e.g., iron fines, other metal fines), a particulate material from another processing (e.g., blast furnace dust, baghouse fines, waste materials, petroleum coke breeze, anthracite fines, calcined anthracite fines), or the like, or a combination thereof. Additional examples of such particulate materials include iron ore pellet fines, Direct Reduced Iron (DRI) pellet fines, DRI/Hot Briquetted Iron (HBI) pellet fines, quench pond dippings (QPD), spilled coal and coke recovery materials, coal wash plant refuse material, or the like, or a combination thereof. Such particulate materials may be unsuitable for an application directly. For example, unlike coke, coke breeze is unsuitable to be used in a blast furnace for steel making. In some cases, although such particulate materials may include useful compositions, due to the difficulty involved in using them directly, they are disposed, which often incurs a cost. Pellets including and/or made of such particulate materials may be used in various applications. The mixed particulate materials may be pelletized alone or mixed with the particulates produced in the heat processing of an input material described elsewhere in the present disclosure.

In some embodiments, the feedstock to the oven 220, the particulates produced by the heat processing of the feedstock in the oven 220, and/or the additional particulate materials to be mixed with the particulates produced by the heat processing of the feedstock in the oven 220 may include minerals, metal oxides, metal halides, metal sulfates, aluminum and silicon minerals, industrial waste, recycle streams, or unwashed coal. Examples of the minerals include limestone, quicklime, dolomite, trona, calcium bearing, iron bearing (e.g., hematite, magnetite), magnesium bearing, or the like, or a combination thereof. Examples of the metal oxides include Al₂O₃, SiO₂, CaO, Fe₂O₃, MgO, Na₂O, TiO, a transitional metal oxide, a calcined mineral, or the like, or a combination thereof. Examples of the metal halides include CaCl₂, MgCl₂, NaCl, or the like, or a combination thereof. Examples of the metal sulfates include CaSO₄, or the like, or a combination thereof. Examples of the aluminum and silicon minerals include quartz, muscovite, feldspar, or the like, or a combination thereof. Examples of the industrial waste and recycle streams include blast furnace slag (or referred to as blast furnace dust), foundry cupola slag, metal fines, wallboard waste, FGD waste (fly ash), coal burning plant fly ash, or heat recovery steam generator (HRSG) wash mud, or the like, or a combination thereof.

In some embodiments, before pelletization, the particulates 230 may be tuned such that the produced pellets have a desired property, e.g., a property specified by a downstream user or determined according to an intended use of the produced pellets. For example, an additive may be added to the particulates. Merely by way of example, at least one of limestone, quicklime, or dolomite may be ground and mixed with the particulates 230 by a grinder or mill. As another example, before being pelletized, the particulates 230 may undergo one or more other pre-processing including, e.g., adjusting water content, milling, grinding, or the like, or a combination thereof.

For example, the particulates may be ground or milled before being pelletized. As another example, a mixture of the particulates 230 and a second particulate material from a different source other than the heat processing of the input material 210 in the oven 220 may be ground or milled before being pelletized. As a further example, a second particulate material may be ground before being mixed with the particulates 230 and pelletized. In some embodiments, particulate materials of a same source or different sources may have different dimensions. By grinding and/or milling, the particulate materials may have a suitable dimension for subsequent pelletization operations. For example, a particulate material includes a waste material a portion of which has a dimension too large to be pelletized alone or with another particulate material (e.g., particulates 230), the waste material may be ground or milled to reduce its dimension so that it is suitable for pelletization. As another example, a pellet product of the production system 200 may have different dimensions. The pellet product may go through a size selection to separate pellets of different dimensions; pellets whose dimensions do not satisfy a dimension specification (outside the range of desired dimensions) may be ground or milled and pelletized again alone or in combination with another particulate material (e.g., particulates 230, a particulate material from a different source than the particulates 230).

For simplicity, the following descriptions are provided with reference to particulates 230, regardless of whether they are a mixture of particulate materials of different sources, or whether they are pre-processed and/or tuned. That is, the particulates 230 may include particulates from the heat processing of an input material described elsewhere in the present disclosure alone, or in combination with another particulate material from a different source as described herein.

In some embodiments, the pelletization assembly 240 may be configured to mix the particulates 230 with one or more additives, such as at least one of a binder or a cross-linker. For example, the pelletization assembly 240 may include a mixer. In some embodiments, the mixing of the particulates 230 with at least one of a binder or a cross-linker is done manually. The particulates 230 (or other particulate materials to be pelletized) may have a suitable property to allow or facilitate the pelletization to proceed. Examples of such properties include surface chemistries, surface morphologies, pi-stacking sites, etc., of the particulates 230 (or other particulate materials to be pelletized). Merely by way of example, such properties include surface areas, porosities, surface tensions, surface charges, or the like, or a combination thereof, of the particulates 230 (or other particulate materials to be pelletized). In some embodiments, the mixer is configured to mix the particulates 230 with a second particulate material that is from a source other than the processing of the input material 210 in the oven 220.

In some embodiments, the particulates 230 may be blended with and/or bound by one or more additives, such as the binder. In some embodiments, the binding of the pelletization may occur at room temperature or other temperature less than 200° F., 150° F., or 100° F. In some embodiments, the binder is hydrophobic, hydrophilic, or amphipathic. In some embodiments, the binder is hydrophilic. Examples of suitable binders include molasses, carboxymethyl guar, hydroxypropyl carboxymethyl guar, Acacia gum, Xanthan gum, starches, modified starches, sodium alginate, carboxymethyl cellulose, hydroxyethyl cellulose, hydroxyethyl methyl cellulose (Tylose), water-soluble synthetic polymers (e.g., polyvinyl alcohol (PVOH, PVA, or PVAl)). Merely by way of example, the particulates 230 may have a relatively high water content, e.g., 30%, 40%, or 50%, and the binder may be or become hydrophobic such that water content in the particulates 230 may be expelled by the binder. The process of reducing water content from (e.g., drying) the particulates 230 may proceed without an extra input of, e.g., heat, such as at room temperature or other temperature less than 200° F., 150° F., or 100° F.

In some embodiments, the binder is in a first state prior to being blended with the particulates 230 and/or processed materials. Upon being blended with the particulates 230 and/or at least some of the processed materials, the binder can be configured to switch from the first state to a second state. The binder can be more hydrophilic in the first state than in the second state such that the binder can bind to the particulates 230, which may have a relatively high water content as discussed above. The binder can be more hydrophobic in the second state than in the first state such that the binder can expel water content (e.g., dry) the particulates 230 and/or the processed materials without the use of thermal treatments, which can be costly.

A cross-linker may include a composition that is used to tune the particulates 230 as discussed elsewhere in the present disclosure. Examples of suitable cross-linkers may include water, limestone, calcium, aluminum, magnesium, sodium, borax, iron, nickel, cobalt, molybdenum, platinum, palladium, cadmium, ammonia, zirconium, potassium, or a mixture thereof. The cross-linker can be a homobifunctional or heterobifunctional cross-linker. The cross-linker may remain in the produced pellets 250.

In some embodiments, the output rate of the pelletization assembly 240 may be at least one ton per hour, 2 tons per hour, 3 tons per hour, 5 tons per hour, 6 tons per hour, 8 tons per hour, 10 tons per hour, 12 tons per hour, 15 tons per hours, 16 tons per hour, 18 tons per hour, or 20 tons per hour. In some embodiments, the pelletization assembly 240 may have a modular configuration in which one or more pelletization units may be used.

In some embodiments, the pelletization assembly 240 may be set up in a vicinity of the oven 220. For instance, the pelletization assembly 240 may be set up in the plant 10 where the oven 100 and one or more other ovens 100 are located. In some embodiments, the pelletization assembly 240 may be set up as a portable facility so that it can be transported to where particulate materials, e.g., particulates 230, one or more other particulate materials, are available for pelletization. In some embodiments, the pelletization assembly 240 may have a modular configuration such that a certain number of pelletization units can be assembled at a location. In some embodiments, the number of pelletization units of the pelletization assembly 240 can be adjusted depending on the processing needs at that location, or a change thereof, from time to time.

It is understood that the description of the production system 200 is provided for illustration purposes and not intended to be limiting. In some embodiments, the production system 200 may omit the oven 220 and include the pelletization assembly 240. The pelletization assembly 240 may pelletize a particulate material from a single source, or a mixture of particulate materials from multiple sources. For example, the pelletization assembly 240 may pelletize one or more particulate materials including at least one of charcoal fines, coal fines, petroleum coke breeze, coke breeze, iron fines, other metal fines, blast furnace dust, baghouse fines, waste materials, petroleum coke breeze, anthracite fines, calcined anthracite fines, iron ore pellet fines, Direct Reduced Iron (DRI) pellet fines, DRI/Hot Briquetted Iron (HBI) pellet fines, or the like, quench pond dippings (QPD), spilled coal and coke recovery materials, coal wash plant refuse material, or a combination thereof. Merely by way of example, the pelletization assembly 240 may pelletize blast furnace dust that includes blast furnace iron fines.

### III. Pellets

In some embodiments, a population pellets 250 may be produced. In some embodiments, individual pellets of the population of pellets 250 may include at least one of calcium, aluminum, magnesium, sodium, iron, nickel, cobalt, molybdenum, platinum, palladium, cadmium, ammonia, zirconium, potassium, or a mixture thereof. In some embodiments, the individual pellets 250 may include an oxide. In some embodiments, the individual pellets 250 may include at least one of iron-containing pellets, N-containing pellets, carbon-containing pellets, etc. Examples of carbon-containing pellets include coke pellets, char pellets, biochar pellets, petroleum coke pellets, anthracite pellets, calcined anthracite pellets, etc. In some embodiments, individual pellets of the population of pellets 250 may include at least one of coke breeze, coal fines, charcoal fines, biochar fines, blast furnace dust, baghouse fines, petroleum coke, anthracite, calcined anthracite, quench pond dippings (QPD), spilled coal and coke recovery materials, coal wash plant refuse material, or waste materials. In some embodiments, individual pellets 250 may include a component of interest including, e.g., carbon, nitrogen, oxygen, an alkali metal, aluminum, iron, or a transition metal. For instance, the component of interest of the individual pellets may be at least 30%, 40%, 50%, 60%, 70%, 80%, or 90% of the individual pellets 250 by weight.

In some embodiments, the individual pellets 250 may have a dimension suitable for their intended use. In some embodiments, individual pellets 250 may have a diameter of at least 1/25″, 1/23″, 1/20″, 1/16″, 1/10″, ⅛″, ⅕″, ¼″, ⅓″, ½″, ¾″, 1″, or in a range from 1/25 inches to 1.5 inches, in a range from ⅕ inches to 1.5 inches, in a range from ¼ inches to 1 inch, or in a range from ½ inches to 1 inch. For example, iron-containing pellets may be further processed to produce steel in, e.g., an electric arc furnace; such iron-containing pellets may have a diameter of ¼ inches to 1 inch, or ½ inches to 1 inch. As another example, pellets so produced may be used as fuel for a specific type of burner, an animal feed, a fertilizer, a cleaning agent configured to filter air, water, etc., and therefore has a suitable property profile including, e.g., dimension, density, surface area, porosity, and composition, or the like, or a combination thereof.

In some embodiments, the individual pellets 250 include a mixture or combination of charred products (e.g., charcoal, biochar) and one or more coal blends. In some embodiments, the individual pellets 250 include a mixture or combination of charred products and one or more coke products. In some embodiments, the charred products are in a ground form (e.g., with an average size of about 2-4 mm or 10-mesh). In some embodiments, the mass ratio of charred products in the individual pellets 250 is 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 30%, or within a range of 1-30%.

In some embodiments, individual pellets 250 include a volatile matter content of 0.1%, 0.3%, 0.5%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, or within a range of 0.1-25%.

In some embodiments, the density of the individual pellets 250 may be different from the density of the particulates 230. For example, the density of the individual pellets 250 may be higher than the density of the particulates 230.

In some embodiments, the individual pellets 250 include a density of at least 1 g/cm³, or in a range from 1.2 g/cm³ to 2.5 g/cm³, or in a range from 1.5 g/cm³ to 1.8 g/cm³.

In some embodiments, the individual pellets 250 include a strength of at least 10 pound per square inch (psi), 20 psi, 30 psi, 40 psi, 50 psi, 60 psi, 70 psi, 80 psi, 90 psi, 100 psi, 120 psi, or in a range from 10 psi to 120 psi, a range from 10 psi to 100 psi, a range from 20 psi to 90 psi, or a range from 40 psi to 80 psi.

In some embodiments, the individual pellets 250 include carbon-containing pellets. The individual pellets 250 include a heat of combustion of at least 150 kJ/mol, 180 kJ/mol, 200 kJ/mol, 220 kJ/mol, 250 kJ/mol, or 260 kJ/mol, 280 kJ/mol, 300 kJ/mol, 320 kJ/mol, in a range from 150 kJ/mol to 350 kJ/mol, in a range from 180 kJ/mol to 350 kJ/mol, or in a range from 200 kJ/mol to 350 kJ/mol.

In some embodiments, the individual pellets 250 include a water content of below 1%, 2%, 3%, 4%, 5%, 6%, 8%, 10%, 12%, 15%, in a range from 2% to 12%, in a range from 4% to 10%, or in a range from 5% to 10%.

In some embodiments, individual pellets 250 include an ash content of 0.1-9%, 3-8%, 4-6%, 5-6%, or no more than 8%, 7%, 6%, 5%.

In some embodiments, the individual pellets 250 include a sulfur content of below 0.05%, 0.1%, 0.2%, 0.5%, 0.6%, 0.7%, 0.8%, 1%, 1.5%, 1.8%, 2%, 2.5%, 2.8%, 3%, 3.5%, 4%, in a range from 0.05% to 1%, in a range from 0.2% to 1%, in a range from 0.4% to 1%, or in a range from 0.5% to 1%, 0.1% to 1.5%, in a range from 0.2% to 1.5%, in a range from 0.4% to 1.5%, or in a range from 0.5% to 1.5%, 0.1% to 2%, in a range from 0.2% to 2%, in a range from 0.4% to 2%, or in a range from 0.5% to 2%, 1% to 1.5%, in a range from 1% to 2%, in a range from 1% to 2.5%, or in a range from 1% to 3%.

In some embodiments, the individual pellets 250 include a calcium oxide content of at least 60%, 65%, 70%, 75%, 78%, or within a range of 60-78%.

In some embodiments, the individual pellets 250 include a charred product:fines ratio of at least 2.0, 2.5, 3.0, 3.5, 4.0, 4.5, 5.0, 5.5, 6.0, 6.5, 7.0, 8.0, 9.0, 10.0, or within a range of 2.0-10.0.

In some embodiments, the individual pellets 250 include a chelation agent.

In some embodiments, the individual pellets 250 have a shape of a cylinder, a sphere, and/or an ovoid.

In some embodiments, the individual pellets 250 have a predetermined degradation profile. For instance, the individual pellets 250 have a predetermined degradation profile that the individual pellets break into chunks.

### IV. Production Process

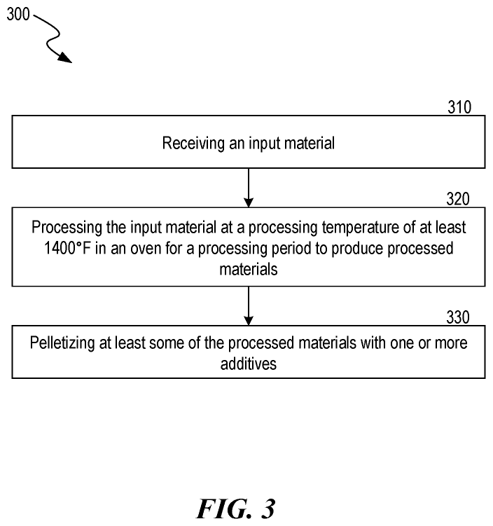

FIG. 3 depicts a flowchart illustrating a production process or method 300 for producing a population of pellets in accordance with embodiments of the present technology.

The method 300 can include receiving an input material (process portion 310). The input materials may be received at an oven. In some embodiments, the oven may be a heat processing oven including, e.g., a devolatilization oven, a pyrolysis oven, or a blast furnace. In some embodiments, the input material may be milled or grinded to reduce its dimension before provided to the oven for heat processing. Descriptions of the input material may be found elsewhere in the present disclosure, and not repeated here.

The method 300 can also include processing the input material at a processing temperature of at least 1400° F. in an oven for a processing period to produce processed materials (process portion 320). In some embodiments, the processing temperature can be at least other temperature values (e.g., at least 1600° F.), as described elsewhere herein. In some embodiments, the processed materials comprise coke, coke breeze, char, charcoal fines, biochar, and/or biochar fines. Descriptions of these processed materials and other processed materials may be found elsewhere in the present disclosure, and not repeated here. In some embodiments, the processing of the input material in the oven may include a pyrolysis process. In some embodiments, the processed materials include pyrolysis products. One or more modifiers may be used in the heat processing. The one or more modifiers may include a mineral oxide modifier. Examples of modifiers include CaO, SiO₂, MgO, or the like, or a combination thereof. In some embodiments, the modifiers can ash composition modifiers, gasification reaction modifiers, etc. The type and/or amount of the modifiers used may be determined or adjusted based on factors including, e.g., input material, component of interest in the input material and/or pellets to be produced, the devices used in the heat processing and/or pelletization, or the like, or a combination thereof. For instance, for the processing of an input material to produce a population of pellets, CaO/SiO₂ ratio and MgO content in the heat processing cycle may be determined accordingly. The processed materials may include particulates. By way of the heat processing, volatiles may be removed from the input material. The content of a component of interest may be increased. One or more properties may also be improved or adjusted for subsequent application or processing. For instance, particulates of the processed materials may have one or more surface chemistries and/or morphological/microstructural properties that allow or facilitate pelletization thereof. Examples of such properties include surface areas, porosities, surface tensions, surface charges, pi-stacking sites, or the like, or a combination thereof, of the particulates so produced. Descriptions of the heat processing of the input material, including the operations parameters of the heat processing, the oven and the control thereof, the processed materials, particulates in the processed materials, etc., may be found elsewhere in the present disclosure, and not repeated here.

The method 300 can further include pelletizing at least some of the processed materials with one or more additives to produce a population of pellets (process portion 330). Descriptions of the additives may be found elsewhere in the present disclosure, and not repeated here. The pelletization process may include one or more of pre-processing (e.g., adjusting water content, milling, grinding), tuning, mixing with another particulate material, etc. Relevant descriptions of details of the operations including operation conditions, devices involved, control or optimization of the operations, intermediate and/or final products produced, properties of such intermediate and/or final products so produced, etc., may be found elsewhere in the present disclosure, and not repeated here.

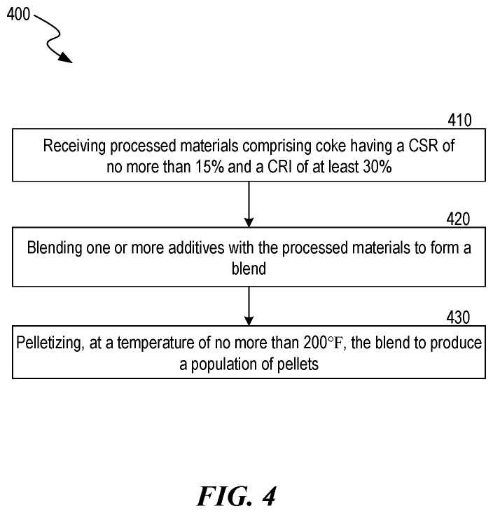

FIG. 4 depicts a flowchart illustrating a production process or method 400 for producing a population of pellets in accordance with embodiments of the present technology. The method 400 can include receiving processed materials comprising coke having a CSR of no more than 15% and a CRI of at least 30% (process portion 410). In some embodiments, the processed materials comprise input material (e.g., material including carbon and/or a non-metal) that has been processed in an oven. In some embodiments, the processed materials additionally or alternatively comprise coke breeze, char, charcoal fines, biochar, and/or biochar fines.

The method 400 can also include blending one or more additives with the processed materials to form a blend (process portion 420). In some embodiments, the one or more additives comprise at least one of (i) a binder comprising at least one of molasses, carboxymethyl guar, hydroxypropyl carboxymethyl guar, Acacia gum, Xanthan gum, starches, modified starches, sodium alginate, carboxymethyl cellulose, hydroxyethyl cellulose, hydroxyethyl methyl cellulose (Tylose), or polyvinyl alcohol, (ii) a cross-linker comprising at least one of water, limestone, calcium, aluminum, magnesium, sodium, borax, iron, nickel, cobalt, molybdenum, platinum, palladium, cadmium, ammonia, zirconium, or potassium, or (iii) a homobifunctional or heterobifunctional cross-linker. In some embodiments, the one or more additives comprise a binder configured to switch from a first state to a second state upon being blended with at least some of the processed materials, wherein the binder is more hydrophobic and less hydrophilic in the second state than in the first state.

The method 400 can further include pelletizing, at a temperature of no more than 200° F. (e.g., room temperature), the blend to produce a population of pellets (process portion 430). In some embodiments, pelletizing comprises pelletizing the blend without applying thermal treatment to the blend.

The method 300 can include additional or alternative steps. For example, the method 300 can include producing a mixture by mixing the processed materials with the one or more additives by (i) grinding at least one of limestone, quicklime, or dolomite and (ii) mixing the ground limestone, quicklime, or dolomite with the processed materials.

It is understood that the description of the production method 300 is provided for illustration purposes and not intended to be limiting. In some embodiments, one or more operations in the production method 300 may omitted or revised. For instance, the pelletization operation 330 may be performed on a particulate material from a single source, or a mixture of particulate materials from multiple sources. Examples of such one or more particulate materials include at least one of charcoal fines, coal fines, petroleum coke breeze, coke breeze, iron fines, other metal fines, blast furnace dust, baghouse fines, waste materials, petroleum coke breeze, anthracite fines, calcined anthracite fines, iron ore pellet fines, Direct Reduced Iron (DRI) pellet fines, DRI/Hot Briquetted Iron (HBI) pellet fines, quench pond dippings (QPD), spilled coal and coke recovery materials, coal wash plant refuse material, or the like, or a combination thereof. Merely by way of example, the pelletization may be performed on blast furnace dust that includes blast furnace iron fines alone.

### V. Conclusion

Although the technology has been described in language that is specific to certain structures, materials, and methodological steps, it is to be understood that the invention defined in the appended claims is not necessarily limited to the specific structures, materials, and/or steps described. Rather, the specific aspects and steps are described as forms of implementing the claimed invention. Further, certain aspects of the new technology described in the context of particular embodiments may be combined or eliminated in other embodiments. Moreover, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein. Thus, the disclosure is not limited except as by the appended claims. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

### Examples

The present technology is illustrated, for example, according to various aspects described below as enumerated embodiments (1, 2, 3, etc.) for convenience. These are provided as examples and do not limit the present technology. It is noted that any of the dependent embodiments can be combined in any combinations, and placed into a respective independent embodiment.
1. A production system, comprising:
a heat processing assembly comprising an oven, wherein:
   the oven is configured to process an input material at a processing temperature of at least 1,000° F. for a processing period to produce processed materials,
   the input material comprises at least one of carbon, nitrogen, oxygen, an alkali metal, aluminum, iron, or a transition metal, and
   the processed materials comprise at least one of coke, coke breeze, char, charcoal fines, biochar, or biochar fines, carbon-containing materials; and
a pelletization assembly configured to pelletize at least some of the processed materials and one or more additives to generate a population of pellets.
2. The production system of any one of the clauses herein, wherein the processed materials comprise particulates, and wherein the pelletization assembly is configured to pelletize the particulates to generate the population of pellets.
3. The production system of any one of the clauses herein, wherein the input material comprises at least one of a carbonaceous feedstock, a non-metal feedstock, or a metal-containing feedstock.
4. The production system of any one of the clauses herein, wherein the input material comprises a carbonaceous feedstock including at least one of coal, wood, a petroleum residue, a biomass feedstock, or a waste feedstock.
5. The production system of any one of the clauses herein, wherein the input material comprises a metal-containing feedstock including a raw mineral material or a recycled metal-containing material.
6. The production system of any one of the clauses herein, wherein at least some of the input material have a smallest cross-sectional dimension of at least 2 inches, 3 inches, 4 inches, 5 inches, or 6 inches.
7. The production system of any one of the clauses herein, further comprising a grinder or mill configured to reduce a size of the input material before providing the input material to the oven.
8. The production system of any one of the clauses herein, wherein the processing period is no more than 18 hours, 12 hours, 8 hours, 6 hours, or 4 hours.
9. The production system of any one of the clauses herein, wherein the processing period is determined based on an operation parameter relating to the processing in the oven.
10. The production system of any one of the clauses herein, wherein the processing period is determined based on an operation parameter relating to the processing in the oven, and wherein the operation parameter comprises at least one of a temperature at an opening of the oven, a composition of an exhaust of the oven, a temperature at a location inside the oven, a temperature at an external surface of the oven, or a temperature at a location inside the processed materials.
11. The production system of any one of the clauses herein, wherein during at least a portion of the processing period, the processing temperature is above 1,000° F., 1,100° F., 1,200° F., 1,300° F., 1,400° F., 1,500° F., 1,600° F., 1,800° F., 2,000° F., 2,500° F., or up to 2800° F.
12. The production system of any one of the clauses herein, wherein the oven is further configured to allow the processed materials to cool in the oven.
13. The production system of any one of the clauses herein, wherein the oven comprises a coke oven.
14. The production system of any one of the clauses herein, wherein the oven is a heat-recovery oven or a non-heat recovery oven.
15. The production system of any one of the clauses herein, wherein:
the oven is a first oven,
the production system further comprises a second oven on one side of the first oven and a third oven on an opposing side of the first oven,
the second oven and the third oven are each thermally coupled to the first oven, and
the second oven and/or the third oven is a source of heat to the first oven.
16. The production system of any one of the clauses herein, wherein
the oven is a first oven, and
the production system further comprises:
   a second oven configured to heat materials that undergo an exothermic process, wherein the second oven is in thermal communication with the first oven such that at least a portion of the heat generated in the exothermic process in the second oven is transferred to the first oven.
17. The production system of any one of the clauses herein, wherein the one or more additives comprise at least one of a binder or a cross-linker.
18. The production system of any one of the clauses herein, wherein the one or more additives comprise at least one of a binder or a cross-linker, and wherein the binder is hydrophobic or hydrophilic.
19. The production system of any one of the clauses herein, wherein:
the one or more additives comprise at least one of a binder or a cross-linker,
the pelletization assembly further comprises a mixer or mill configured to mix the particulates with the one or more additives, and
the binder includes at least one of molasses, carboxymethyl guar, hydroxypropyl carboxymethyl guar, Acacia gum, Xanthan gum, starches, modified starches, sodium alginate, carboxymethyl cellulose, hydroxyethyl cellulose, hydroxyethyl methyl cellulose (Tylose), or polyvinyl alcohol.
20. The production system of any one of the clauses herein, wherein the pelletization assembly further comprises a grinder or mill configured to grind and/or combine at least one of limestone, quicklime, or dolomite with the particulates.
21. The production system of any one of the clauses herein, wherein the pelletization assembly further comprises a grinder or mill configured to grind or mill at least a portion of the processed materials before the pelletization.
22. The production system of any one of the clauses herein, wherein individual pellets of the population of pellets comprise at least one of calcium, aluminum, magnesium, sodium, iron, nickel, cobalt, molybdenum, platinum, palladium, cadmium, ammonia, zirconium, or potassium.
23. The production system of any one of the clauses herein, wherein the individual pellets comprise an oxide.
24. The production system of any one of the clauses herein, wherein the particulates comprise at least one of charcoal fines, biochar fines, or coke breeze.
25. The production system of any one of the clauses herein, wherein the pelletization assembly comprises a mixer configured to mix the particulates with a second particulate material that is from a source other than the processing of the input material in the oven.
26. The production system of any one of the clauses herein, wherein
the pelletization assembly comprises a mixer configured to mix the particulates with a second particulate material that is from a source other than the processing of the input material in the oven, and
the second particulate material comprises coal fines, iron fines, iron ore pellet fines, Direct Reduced Iron (DRI) pellet fines, DRI/Hot Briquetted Iron (HBI) pellet fines, blast furnace dust, metal fines, baghouse fines, quench pond dippings (QPD), spilled coal and coke recovery materials, coal wash plant refuse material, or waste materials.
27. The production system of any one of the clauses herein, wherein the individual pellets comprise char and/or biochar.
28. The production system of any one of the clauses herein, wherein the individual pellets comprise a diameter of at least 1/25″, 1/23″, 1/20″, 1/16″, 1/10″, ⅛″, ⅕″, ¼″, ⅓″, ½″, ¾″, 1″, or in a range from 1/25 inches to 1.5 inches, in a range from ⅕ inches to 1.5 inches, in a range from ¼ inches to 1 inch, or in a range from ½ inches to 1 inch.
29. The production system of any one of the clauses herein, wherein an output rate of the pelletization assembly is at least one ton per hour, 2 tons per hour, 3 tons per hour, 5 tons per hour, 6 tons per hour, 8 tons per hour, 10 tons per hour, 12 tons per hour, 15 tons per hours, 16 tons per hour, 18 tons per hour, or 20 tons per hour.
30. The production system of any one of the clauses herein, wherein
the particulates have a first density, and
the individual pellets have a second density higher than the first density.
31. A population of pellets comprising particulates and one or more additives, wherein:
the one or more additives comprise at least one of a binder or a cross-linker, and
individual pellets comprise carbon, nitrogen, oxygen, an alkali metal, aluminum, iron, or a transition metal.
32. The population of pellets of any one of the clauses herein, wherein the population of pellets comprises char and/or biochar.
33. The population of pellets of any one of the clauses herein, wherein the population of pellets comprises at least one of coke breeze, coal fines, charcoal fines, biochar fines, blast furnace dust, baghouse fines, petroleum coke, anthracite, calcined anthracite, quench pond dippings (QPD), spilled coal and coke recovery materials, coal wash plant refuse material, or waste materials.
34. The population of pellets of any one of the clauses herein, wherein the population of pellets comprises iron fines or metal fines.
35. The population of pellets of any one of the clauses herein, wherein the individual pellets comprise at least one component including calcium, aluminum, magnesium, sodium, iron, nickel, cobalt, molybdenum, platinum, palladium, cadmium, ammonia, zirconium, or potassium.
36. The population of pellets of any one of the clauses herein, wherein the individual pellets comprise an oxide.
37. The population of pellets of any one of the clauses herein, wherein the population of pellets is produced by a process comprising:
receiving the input material;
heating, in an oven, the input material at a temperature of at least 1,000° F. for a processing period to generate processed materials; and
pelletizing at least a portion of the processed materials to produce the population of pellets.
38. The population of pellets of any one of the clauses herein, wherein the processed materials comprise at least one of coke, coke breeze, char, biochar, charcoal fines, biochar fines, or carbon-containing materials.
39. The population of pellets of any one of the clauses herein, wherein:
the processed materials comprise particulates, and
the pelletizing at least a portion of the processed materials to produce the population of pellets comprises pelletizing the particulates to generate the population of pellets.
40. The population of pellets of any one of the clauses herein, wherein the individual pellets comprise a density of at least 1 g/cm³, or in a range from 1.2 g/cm³ to 2.5 g/cm³, or in a range from 1.5 g/cm³ to 1.8 g/cm³.
41. The population of pellets of any one of the clauses herein, wherein the individual pellets comprise a diameter of at least 1/25″, 1/23″, 1/20″, 1/16″, 1/10″, ⅛″, ⅕″, ¼″, ⅓″, ½″, ¾″, 1″, or in a range from 1/25 inches to 1.5 inches, in a range from 1/15 inches to 1.5 inches, in a range from ¼ inches to 1 inch, or in a range from ½ inches to 1 inch.
42. The population of pellets of any one of the clauses herein, wherein the individual pellets comprise a strength of at least 10 pound per square inch (psi), 20 psi, 30 psi, 40 psi, 50 psi, 60 psi, 70 psi, 80 psi, 90 psi, 100 psi, 120 psi, or in a range from 10 psi to 120 psi, a range from 10 psi to 100 psi, a range from 20 psi to 90 psi, or a range from 40 psi to 80 psi.
43. The population of pellets of any one of the clauses herein, wherein the individual pellets comprise a heat of combustion of at least 150 kJ/mol, 180 kJ/mol, 200 kJ/mol, 220 kJ/mol, 250 kJ/mol, or 260 kJ/mol, 280 kJ/mol, 300 kJ/mol, 320 kJ/mol, in a range from 150 kJ/mol to 350 kJ/mol, in a range from 180 kJ/mol to 350 kJ/mol, or in a range from 200 kJ/mol to 350 kJ/mol.
44. The population of pellets of any one of the clauses herein, wherein the individual pellets comprise a water content of below 1%, 2%, 3%, 4%, 5%, 6%, 8%, 10%, 12%, 15%, in a range from 2% to 12%, in a range from 4% to 10%, or in a range from 5% to 10%.
45. The population of pellets of any one of the clauses herein, wherein the individual pellets comprise a sulfur content of below 0.2%, 0.5%, 0.6%, 0.8%, 1%, 1.5%, 1.8%, 2%, 2.5%, 2.8%, 3%, 3.5%, 4%, in a range from 0.1% to 1%, in a range from 0.2% to 1%, in a range from 0.4% to 1%, in a range from 0.5% to 1%, in a range from 0.1% to 1.5%, in a range from 0.2% to 1.5%, in a range from 0.4% to 1.5%, or in a range from 0.5% to 1.5%, 0.1% to 2%, in a range from 0.2% to 2%, in a range from 0.4% to 2%, or in a range from 0.5% to 2%, 1% to 1.5%, in a range from 1% to 2%, in a range from 1% to 2.5%, or in a range from 1% to 3%.
46. The population of pellets of any one of the clauses herein, wherein the individual pellets comprise a chelation agent.
47. The population of pellets of any one of the clauses herein, wherein the individual pellets have a shape of a cylinder, a sphere, and/or an ovoid.
48. The pellet product of any one of the clauses herein, wherein the individual pellets have a predetermined degradation profile.
49. The pellet product of any one of the clauses herein, wherein the individual pellets have a predetermined degradation profile that the individual pellets break into chunks.
50. A production method, comprising:
receiving an input material, wherein the input material comprises at least one of carbon, nitrogen, oxygen, an alkali metal, aluminum, iron, or a transition metal;
processing the input material at a processing temperature of at least 1,000° F. in a oven for a processing period to produce processed materials, wherein the processed materials comprise coke, coke breeze, char, charcoal fines, biochar, biochar fines, or carbon-containing materials; and
pelletizing at least some of the processed materials with one or more additives to produce a population of pellets.
51. The production method of any one of the clauses herein, wherein
the processed materials comprise particulates, and
the pelletizing at least some of the processed materials comprises pelletizing the particulates.
52. The production method of any one of the clauses herein, wherein the input material comprises at least one of a carbonaceous feedstock or a metal-containing feedstock.
53. The production method of any one of the clauses herein, wherein the input material comprises a carbonaceous feedstock including at least one of coal, wood, a petroleum residue, a biomass feedstock, or a waste feedstock.
54. The production method of any one of the clauses herein, wherein the input material comprises a metal-containing feedstock including a raw mineral material or a recycled metal-containing material.
55. The production method of any one of the clauses herein, wherein at least some of the input material have a smallest cross-sectional dimension of at least 2 inches, 3 inches, 4 inches, 5 inches, or 6 inches.
56. The production method of any one of the clauses herein, further comprising:
grinding or milling the input material before providing the input material to the oven.
57. The production method of any one of the clauses herein, wherein the processing period is no more than 5 days, 3 days, 2 days, 1 day, 18 hours, 12 hours, 8 hours, 6 hours, or 4 hours.
58. The production method of any one of the clauses herein, wherein the processing the input material at a processing temperature of at least 1,000° F. in an oven for a processing period to produce processed materials comprises:
receiving an operation parameter relating to the processing in the oven; and
determining the processing period based on the operation parameter.
59. The production method of any one of the clauses herein, wherein the processing the input material at a processing temperature of at least 1,000° F. in an oven for a processing period to produce processed materials comprises:
receiving an operation parameter relating to the processing in the oven, the operation parameter comprising at least one of a temperature at an open of the oven, a composition of an exhaust of the oven, a temperature at a location inside the oven, a temperature at an external surface of the oven, or a temperature at a location inside the processed materials; and
determining the processing period based on the operation parameter.
60. The production method of any one of the clauses herein, wherein during at least a portion of the processing period, the processing temperature is above 1,000° F., 1,100° F., 1,200° F., 1,300° F., 1,400° F., 1,500° F., 1,600° F., 1,800° F., 2,000° F., 2,500° F., or up to 2800° F.
61. The production method of any one of the clauses herein, further comprising:
providing at least one of a desulfurizing agent or a chelating agent to the oven during the processing period.
62. The production method of any one of the clauses herein, further comprising:
allowing the processed material to cool in the oven.
63. The production method of any one of the clauses herein, wherein the oven comprises a coke oven.
64. The production method of any one of the clauses herein, wherein the oven is a heat-recovery oven or a non-heat recovery oven.
65. The production method of any one of the clauses herein, wherein
the oven is a first oven that is in thermal communication with a second oven and a third oven,
the second oven and the third oven are positioned on opposite sides of the first oven,
the second oven and/or the third oven is a source of heat to the first oven, and
the production method further comprises transferring, during the processing period, at least a portion of the heat generated in the second oven and/or the third oven to the first oven.
66. The production method of any one of the clauses herein, wherein
the oven is a first oven in thermal communication with a second oven configured to heat materials that undergo an exothermic process, and
the production method further comprises transferring, during the processing period, at least a portion of the heat generated in the exothermic process in the second oven to the first oven.
67. The production method of any one of the clauses herein, further comprising:
separating the particulates from the processed materials.
68. The production method of any one of the clauses herein, further comprising:
grinding or milling at least a portion of the processed materials before the pelletization.
69. The production method of any one of the clauses herein, further comprising:
mixing the particulates with a second particulate material that is from a source other than the processing of the input material in the oven.
70. The production method of any one of the clauses herein, further comprising:
mixing the particulates with a second particulate material that is from a source other than the processing of the input material in the oven, wherein the second particulate material comprises coal fines, iron fines, iron ore pellet fines, Direct Reduced Iron (DRI) pellet fines, DRI/Hot Briquetted Iron (HBI) pellet fines, blast furnace dust, metal fines, baghouse fines, petroleum coke breeze, anthracite fines, calcined anthracite fines, quench pond dippings (QPD), spilled coal and coke recovery materials, coal wash plant refuse material, or waste materials.
71. The production method of any one of the clauses herein, wherein the pelletizing the particulates comprises:
adjusting a water content of the particulates.
72. The production method of any one of the clauses herein, wherein the pelletizing the particulates comprises:
producing a mixture by mixing the particulates with the one or more additives, wherein the one or more additives comprise at least one of a binder or a cross-linker.
73. The production method of any one of the clauses herein, further comprising:
producing a mixture by mixing the particulates with the one or more additives, wherein
   the one or more additives comprise at least one of a binder or a cross-linker at least one of a binder or a cross-linker, and
   the binder is hydrophobic or hydrophilic.
74. The production method of any one of the clauses herein, further comprising:
producing a mixture by mixing the particulates with the one or more additives, wherein the one or more additives comprise a binder or a cross-linker, wherein the binder includes at least one of molasses, carboxymethyl guar, hydroxypropyl carboxymethyl guar, Acacia gum, Xanthan gum, starches, modified starches, sodium alginate, carboxymethyl cellulose, hydroxyethyl cellulose, hydroxyethyl methyl cellulose (Tylose), or polyvinyl alcohol.
75. The production method of any one of the clauses herein, further comprising:
producing a mixture by mixing the particulates with the one or more additives by:
   grinding limestone; and
   mixing the ground limestone with the particulates.
76. The production method of any one of the clauses herein, wherein the individual pellets comprise at least calcium, aluminum, magnesium, sodium, iron, nickel, cobalt, molybdenum, platinum, palladium, cadmium, ammonia, zirconium, or potassium.
77. The production method of any one of the clauses herein, wherein the individual pellets include an oxide.
78. The production method of any one of the clauses herein, wherein the individual pellets comprise char and/or biochar.
79. The production method of any one of the clauses herein, wherein the particulates comprise at least one of charcoal fines, biochar fines, coke breeze, or carbon-containing materials.
80. The production method of any one of the clauses herein, wherein the individual pellets comprise a diameter of at least 1/25″, 1/23″, 1/20″, 1/16″, 1/10″, ⅛″, ⅕″, ¼″, ⅓″, ½″, ¾″, 1″, or in a range from 1/25 inches to 1.5 inches, in a range from ⅕ inches to 1.5 inches, in a range from ¼ inches to 1 inch, or in a range from ½ inches to 1 inch.
81. A production system, comprising:
a heat processing assembly comprising an oven configured to process an input material at a processing temperature of at least 1,000° F. for a processing period of no more than 1 day to produce processed materials,
   wherein the input material comprises at least one of a carbonaceous feedstock or a non-metal feedstock, and
   wherein the processed materials comprise at least one of coke, coke breeze, char, or biochar; and
a pelletization assembly configured to pelletize at least some of the processed materials and one or more additives to generate a population of pellets.
82. The production system of any one of the clauses herein, wherein the input material further comprises a metal feedstock.
83. The production system of any one of the clauses herein, wherein the input material comprises the carbonaceous feedstock including at least one of wood, a petroleum residue, a biomass feedstock, or a waste feedstock.
84. The production system of any one of the clauses herein, wherein at least some of the input material have a smallest cross-sectional dimension of at least 4 inches.
85. The production system of any one of the clauses herein, further comprising a grinder or mill configured to reduce a size of the input material before providing the input material to the oven.
86. The production system of any one of the clauses herein, wherein the processed materials comprise at least one of coke, coke breeze, char, or biochar.
87. The production system of any one of the clauses herein, wherein the processed materials comprise at least two of coke, coke breeze, char, or biochar.
88. The production system of any one of the clauses herein, wherein during at least a portion of the processing period, the processing temperature is above 1,200° F.
89. The production system of any one of the clauses herein, wherein the oven is further configured to allow the processed materials to cool in the oven.
90. The production system of any one of the clauses herein, wherein the oven comprises a coke oven.
91. The production system of any one of the clauses herein, wherein:
the oven is a first oven,
the production system further comprises a second oven on one side of the first oven and a third oven on an opposing side of the first oven,
the second oven and the third oven are each thermally coupled to the first oven, and
the second oven and/or the third oven is a source of heat to the first oven.
92. The production system of any one of the clauses herein, wherein:
the oven is a first oven, and
the production system further comprises:
   a second oven configured to heat materials that undergo an exothermic process, wherein the second oven is in thermal communication with the first oven such that at least a portion of the heat generated in the exothermic process in the second oven is transferred to the first oven.
93. The production system of any one of any one of the clauses herein, wherein the one or more additives comprise a binder that includes at least one of molasses, carboxymethyl guar, hydroxypropyl carboxymethyl guar, Acacia gum, Xanthan gum, starches, modified starches, sodium alginate, carboxymethyl cellulose, hydroxyethyl cellulose, hydroxyethyl methyl cellulose (Tylose), or polyvinyl alcohol.
94. The production system of any one of the clauses herein, wherein the one or more additives comprise at least one of a cross-linker or a binder that is hydrophobic.
95. The production system of any one of the clauses herein, wherein the pelletization assembly further comprises a grinder or mill configured to grind and/or combine limestone with the processed materials.
96. The production system of any one of the clauses herein, wherein individual ones of the population of pellets comprise at least one of calcium, aluminum, magnesium, sodium, iron, nickel, cobalt, molybdenum, platinum, palladium, cadmium, ammonia, zirconium, or potassium.
97. The production system of any one of the clauses herein, wherein:
the pelletization assembly comprises a mixer configured to mix the processed materials with second processed materials that is from a source other than the processing of the input material in the oven, and
the second processed materials comprises at least one of iron fines, iron ore pellet fines, Direct Reduced Iron (DRI) pellet fines, Hot Briquetted Iron (HBI) pellet fines, blast furnace dust, metal fines, baghouse fines, quench pond dippings (QPD).
98. The production system of any one of the clauses herein, wherein individual ones of the population of pellets comprise char and/or biochar.
99. The production system of any one of the clauses herein, wherein individual pellets comprise a diameter of at least 1/16″.
100. The production system of any one of the clauses herein, wherein an output rate of the pelletization assembly is at least three tons per hour.
101. The production system of any one of the clauses herein, wherein:
the processed materials have a first density, and
individual ones of the population of pellets have a second density higher than the first density.
102. A population of pellets, wherein individual pellets comprise:
two or more of coke, coke breeze, char, biochar, charcoal fines, biochar fines, or carbon-containing materials;
at least one of a binder or a cross-linker.
103. The population of pellets of any one of the clauses herein, wherein the population of pellets comprises coke breeze, coal fines, and at least one of charcoal fines or biochar fines.
104. The population of pellets of any one of the clauses herein, wherein the individual pellets further comprise at least one component including calcium, aluminum, magnesium, sodium, iron, nickel, cobalt, molybdenum, platinum, palladium, cadmium, ammonia, zirconium, or potassium.
105. The population of pellets of any one of the clauses herein, wherein the individual pellets comprise an oxide.
106. The population of pellets of any one of the clauses herein, wherein the individual pellets comprise a density in a range from 1.2 g/cm³ to 2.5 g/cm³.
107. The population of pellets of any one of the clauses herein, wherein the individual pellets comprise a diameter of at least ¼″.
108. The population of pellets of any one of the clauses herein, wherein the individual pellets comprise a strength of at least 40 pound per square inch.
109. The population of pellets of any one of the clauses herein, wherein the individual pellets comprise a heat of combustion of at least 200 kJ/mol.
110. The population of pellets of any one of the clauses herein, wherein the individual pellets comprise a water content of below 4%.
111. The population of pellets of any one of the clauses herein, wherein the individual pellets comprise a sulfur content of below 1%.
112. The population of pellets of any one of the clauses herein, wherein the individual pellets have a shape of a cylinder, a sphere, or an ovoid.
113. A production method, comprising:
receiving processed materials comprising coke having a Coke Strength After Reaction (CSR) of no more than 15% and a Coke Reactivity Index (CRI) of at least 30%;
blending one or more additives with the processed materials to form a blend; and
pelletizing, at a temperature of no more than 200° F., the blend to produce a population of pellets.
114. The production method of any one of the clauses herein, further comprising:
grinding or milling the input material before providing the input material to the oven, wherein during at least a portion of the processing period, the processing temperature is above 1,600° F.
115. The production method of any one of the clauses herein, further comprising:
producing a mixture by mixing the processed materials with the one or more additives by:
   grinding limestone to produce ground limestone; and
   mixing the ground limestone with the processed materials.
116. The production method of any one of the clauses herein, wherein individual ones of the population of pellets comprise at least one of calcium, aluminum, magnesium, sodium, iron, nickel, cobalt, molybdenum, platinum, palladium, cadmium, ammonia, zirconium, or potassium.
117. The production method of any one of the clauses herein, wherein the one or more additives comprise at least one of (i) a binder comprising at least one of molasses, carboxymethyl guar, hydroxypropyl carboxymethyl guar, Acacia gum, Xanthan gum, starches, modified starches, sodium alginate, carboxymethyl cellulose, hydroxyethyl cellulose, hydroxyethyl methyl cellulose (Tylose), or polyvinyl alcohol, (ii) a cross-linker comprising at least one of water, limestone, calcium, aluminum, magnesium, sodium, borax, iron, nickel, cobalt, molybdenum, platinum, palladium, cadmium, ammonia, zirconium, or potassium, or (iii) a homobifunctional or heterobifunctional cross-linker.
118. The production method of any one of the clauses herein, wherein the one or more additives comprise a binder configured to switch from a first state to a second state upon being blended with at least some of the processed materials, wherein the binder is more hydrophobic and less hydrophilic in the second state than in the first state.
119. The production method of any one of the clauses herein, wherein pelletizing comprises pelletizing the blend without applying thermal treatment to the blend.

I/We claim:

1. A production system, comprising:
a heat processing assembly comprising an oven configured to process an input material at a processing temperature of at least 1,000° F. to produce processed materials,
wherein the input material comprises at least one of a carbonaceous feedstock or a non-metal feedstock; and
a pelletization assembly configured to pelletize at least some of the processed materials and one or more additives to generate a population of pellets.

2. The production system of claim 1, wherein the input material further comprises a metal feedstock.

3. The production system of claim 1, wherein the input material comprises the carbonaceous feedstock including at least one of wood, a petroleum residue, a biomass feedstock, or a waste feedstock.

4. The production system of claim 1, wherein at least some of the input material have a smallest cross-sectional dimension of at least 4 inches.

5. The production system of claim 1, further comprising a grinder or mill configured to reduce a size of the input material before providing the input material to the oven.

6. The production system of claim 1, wherein the processed materials comprise at least one of coke, coke breeze, char, or biochar.

7. The production system of claim 1, wherein the processed materials comprise at least two of coke, coke breeze, char, or biochar.

8. The production system of claim 1, wherein the oven is configured to process the input material for a processing period of no more than 1 day to produce the processed materials.

9. The production system of claim 1, wherein during at least a portion of the processing period, the processing temperature is above 1,200° F.

10. The production system of claim 1, wherein the oven is further configured to allow the processed materials to cool in the oven.

11. The production system of claim 1, wherein the oven comprises a coke oven.

12. The production system of claim 1, wherein:
the oven is a first oven,
the production system further comprises a second oven on one side of the first oven and a third oven on an opposing side of the first oven,
the second oven and the third oven are each thermally coupled to the first oven, and
the second oven and/or the third oven is a source of heat to the first oven.

13. The production system of claim 1, wherein:
the oven is a first oven, and
the production system further comprises:
a second oven configured to heat materials that undergo an exothermic process, wherein the second oven is in thermal communication with the first oven such that at least a portion of the heat generated in the exothermic process in the second oven is transferred to the first oven.

14. The production system of any one of claim 1, wherein the one or more additives comprise a binder that includes at least one of molasses, carboxymethyl guar, hydroxypropyl carboxymethyl guar, Acacia gum, Xanthan gum, starches, modified starches, sodium alginate, carboxymethyl cellulose, hydroxyethyl cellulose, hydroxyethyl methyl cellulose (Tylose), or polyvinyl alcohol.

15. The production system of claim 1, wherein the one or more additives comprise at least one of a cross-linker or a binder that is amphipathic.

16. The production system of claim 1, wherein the pelletization assembly further comprises a grinder or mill configured to grind and/or combine at least one of limestone, quicklime, or dolomite with the processed materials.

17. The production system of claim 1, wherein individual ones of the population of pellets comprise at least one of calcium, aluminum, magnesium, sodium, iron, nickel, cobalt, molybdenum, platinum, palladium, cadmium, ammonia, zirconium, or potassium.

18. The production system of claim 1, wherein:
the pelletization assembly comprises a mixer configured to mix the processed materials with second processed materials that is from a source other than the processing of the input material in the oven, and
the second processed materials comprises at least one of iron fines, iron ore pellet fines, Direct Reduced Iron (DRI) pellet fines, Hot Briquetted Iron (HBI) pellet fines, blast furnace dust, metal fines, baghouse fines, quench pond dippings (QPD).

19. The production system of claim 1, wherein individual ones of the population of pellets comprise char and/or biochar.

20. The production system of claim 1, wherein individual pellets comprise a diameter of at least 1/16″.

21. The production system of claim 1, wherein an output rate of the pelletization assembly is at least three tons per hour.

22. The production system of claim 1, wherein:
the processed materials have a first density, and
individual ones of the population of pellets have a second density higher than the first density.

23. A population of pellets, wherein individual pellets comprise:
two or more of coke, coke breeze, char, biochar, charcoal fines, biochar fines, or carbon-containing materials;
at least one of a binder or a cross-linker.

24. The population of pellets of claim 23, wherein the population of pellets comprises coke breeze, coal fines, and at least one of charcoal fines or biochar fines.

25. The population of pellets of claim 23, wherein the individual pellets further comprise at least one component including calcium, aluminum, magnesium, sodium, iron, nickel, cobalt, molybdenum, platinum, palladium, cadmium, ammonia, zirconium, or potassium.

26. The population of pellets of claim 23, wherein the individual pellets comprise an oxide.

27. The population of pellets of claim 23, wherein the individual pellets comprise a density in a range from 1.2 g/cm³ to 2.5 g/cm³.

28. The population of pellets of claim 23, wherein the individual pellets comprise a diameter of at least ¼″.

29. The population of pellets of claim 23, wherein the individual pellets comprise a strength of at least 40 pound per square inch.

30. The population of pellets of claim 23, wherein the individual pellets comprise a heat of combustion of at least 200 kJ/mol.

31. The population of pellets of claim 23, wherein the individual pellets comprise a water content of below 4%.

32. The population of pellets of claim 23, wherein the individual pellets comprise a sulfur content of below 1%.

33. The population of pellets of claim 23, wherein the individual pellets have a shape of a cylinder, a sphere, or an ovoid.

34. A production method, comprising:
receiving processed materials comprising coke having a Coke Strength After Reaction (CSR) of no more than 15% and a Coke Reactivity Index (CRI) of at least 30%;
blending one or more additives with the processed materials to form a blend; and
pelletizing, at a temperature of no more than 200° F., the blend to produce a population of pellets.

35. The production method of claim 34, wherein the one or more additives comprise at least one of (i) a binder comprising at least one of molasses, carboxymethyl guar, hydroxypropyl carboxymethyl guar, Acacia gum, Xanthan gum, starches, modified starches, sodium alginate, carboxymethyl cellulose, hydroxyethyl cellulose, hydroxyethyl methyl cellulose (Tylose), or polyvinyl alcohol, (ii) a cross-linker comprising at least one of water, limestone, calcium, aluminum, magnesium, sodium, borax, iron, nickel, cobalt, molybdenum, platinum, palladium, cadmium, ammonia, zirconium, or potassium, or (iii) a homobifunctional or heterobifunctional cross-linker.

36. The production method of claim 34, wherein the one or more additives comprise a binder configured to switch from a first state to a second state upon being blended with at least some of the processed materials, wherein the binder is more hydrophobic and less hydrophilic in the second state than in the first state.

37. The production method of claim 34, wherein pelletizing comprises pelletizing the blend without applying thermal treatment to the blend.
